(19) United States
(12) Patent Application Publication
(10) Pub. No.: US 2026/0331028 A1
(43) Pub. Date: Oct. 22, 2026

(54) DRIVE CONTROL CIRCUIT OF LIGHT-EMITTING DRIVE CIRCUIT, DISPLAY DRIVE CIRCUIT, AND DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventors: Yuanzhou HU, Beijing (CN); Lu ZHANG, Beijing (CN); Jian LI, Beijing (CN); Shuai HOU, Beijing (CN); Guoqiang WU, Beijing (CN)

(21) Appl. No.: 18/881,792

(22) PCT Filed: Jan. 3, 2024
(86) PCT No.: PCT/CN2024/070269

§ 371 Date: Jan. 7, 2025

(51) Int. Cl. G09G 3/32

(52) U.S. Cl. CPC G09G 3/32; G09G 2300/0408; G09G 2310/0267; G09G 2320/0252; G09G 2330/021

(57) ABSTRACT

Provided is a drive control circuit of a light-emitting drive circuit. The drive control circuit includes at least two groups of first drive circuits, wherein the at least two groups of first drive circuits are connected to at least two groups of input control terminals and at least two groups of drive power terminals in one-to-one correspondence. Each group of first drive circuits can control, in response to an input control signal provided by a corresponding connected group of input control terminals, an on-off of the corresponding group of drive power terminals and the output terminal connected to the light-emitting drive circuit.

### CROSS-REFERENCE TO RELATED APPLICATIONS

The present disclosure is a U.S. national phase application based on PCT/CN2024/070269, filed on Jan. 3, 2024, the content of which is herein incorporated by reference in its entirety.

### TECHNICAL FIELD

The present disclosure relates to the field of display technologies, and in particular, to a drive control circuit of a light-emitting drive circuit, a display drive circuit, and a display device.

### BACKGROUND

A display drive circuit is one of the essential circuits of a display device. Typically, the display drive circuit is connected to a pixel in the display device for driving the pixel to emit light.

### SUMMARY

Embodiments of the present disclose provide a drive control circuit of a light-emitting drive circuit, a display drive circuit, and a display device. The technical solutions are described as follows.

In one aspect, a drive control circuit of a light-emitting drive circuit is provided. The drive control circuit includes:
at least two groups of first drive circuits, connected to at least two groups of input control terminals, at least two groups of drive power terminals, and an output terminal configured to connect to the light-emitting drive circuit; wherein levels of drive power signals provided by the at least two groups of drive power terminals are different, the at least two groups of input control terminals are in one-to-one correspondence with the at least two groups of first drive circuits, the at least two groups of drive power terminals are in one-to-one correspondence with the at least two groups of first drive circuits, and the at least two groups of input control terminals are in one-to-one correspondence with the at least two groups of drive power terminals;
wherein each group of the at least two groups of first drive circuits is configured to control, in response to an input control signal provided by a corresponding group of input control terminals, an on-off of a corresponding group of drive power terminals and the output terminal.

In some embodiments, each group of the at least two groups of input control terminals includes a first input control terminal and a second input control terminal; and each group of the at least two groups of drive power terminals includes a first drive power terminal corresponding to the first input control terminal, and a second drive power terminal corresponding to the second input control terminal; wherein a level of a drive power signal provided by the first drive power terminal is greater than a level of the drive power signal provided by the second drive power terminal; and
each group of the at least two groups of first drive circuits is configured to control, in response to an input control signal provided by the first input control terminal, an on-off of the first drive power terminals and the output terminal, and control, in response to an input control signal provided by the second input control terminal, an on-off of the second drive power terminal and the output terminal.

In some embodiments, the each group of the at least two groups of the first drive circuits includes a first transistor and a second transistor;
wherein a gate of the first transistor is connected to the first input control terminal, a first electrode of the first transistor is connected to the first drive power terminal, and a second electrode of the first transistor is connected to the output terminal; and
a gate of the second transistor is connected to the second input control terminal, a first electrode of the second transistor is connected to the second drive power terminal, and a second electrode of the second transistor is connected to the output terminal.

In some embodiments, one of the first transistor and the second transistor is a P-type transistor, and another of the first transistor and the second transistor is an N-type transistor.

In some embodiments, the drive control circuit further includes:
a first signal control circuit, connected to the at least two groups of input control terminals, and configured to transmit an input control signal to each group of the at least two groups of input control terminals.

In some embodiments, the drive control circuit further includes:
a second drive circuit, connected to an enable control terminal, a pull-down power terminal, and the output terminal, and configured to control, in response to an enable control signal provided by the enable control terminal, an on-off of the pull-down power terminal and the output terminal.

In some embodiments, the second drive circuit includes a third transistor;
wherein a gate of the third transistor is connected to the enable control terminal, a first electrode of the third transistor is connected to the pull-down power terminal, and a second electrode of the third transistor is connected to the output terminal.

In some embodiments, the drive control circuit further includes:
a second signal control circuit, connected to the enable control terminal, and configured to transmit an enable control signal to the enable control terminal.

In some embodiments, the drive control circuit further includes:
a power supply circuit, connected to the at least two groups of drive power terminals, and configured to transmit drive power signals with different levels to the at least two groups of drive power terminals.

In some embodiments, the power supply circuit includes:
a level conversion sub-circuit, connected to an input power terminal and an output pin, and configured to perform level conversion on an input power signal provided by the input power terminal and transmit the input power signal that is performed level conversion to the output pin; and
a voltage regulator processing sub-circuit, connected to the output pin and the at least two groups of drive power terminals, and configured to transmit the drive power signals with different levels to the at least two groups of drive power terminals based on the input power signal as received.

In some embodiments, the drive control circuit further includes a display driver integrated chip (DDIC); wherein the level conversion sub-circuit includes:
a charge pump integrated in the DDIC;
and/or, a charge pump independent of the DDIC.

In some embodiments, the level conversion sub-circuit includes a charge pump integrated in the DDIC, and a charge pump independent of the DDIC; and the power supply circuit further includes:
a switch selection sub-circuit, connected to a switch control terminal, the charge pump in the DDIC, and the output pin, and configured to control, in response to a switch control signal provided by the switch control terminal, an on-off of the charge pump in the DDIC and the output pin; and
a switch control sub-circuit, connected to the switch control terminal, and configured to transmit the switch control signal to the switch control terminal.

In some embodiments, the switch selection sub-circuit includes a single-electrode single-throw switch;
wherein a control terminal of the single-electrode single-throw switch is connected to the switch control terminal, a first terminal of the single-electrode single-throw switch is connected to the charge pump in the DDIC, and a second terminal of the single-electrode single-throw switch is connected to the output pin.

In some embodiments, the single-electrode single-throw switch is a high-impedance switch, and the switch control sub-circuit includes a register.

In some embodiments, the switch control sub-circuit and the voltage regulator processing sub-circuit are both integrated in the DDIC.

In some embodiments, the drive control circuit further includes a power management chip (PMIC);

wherein the level conversion sub-circuit includes a charge pump independent of the DDIC, wherein the charge pump independent of the DDIC is integrated in the PMIC, or the charge pump independent of the DDIC is independent of the PMIC.

In some embodiments, the drive control circuit further includes:
at least two groups of amplifiers, connected to the at least two groups of input control terminals and the at least two groups of first drive circuits in one-to-one correspondence, and configured to amplify an input control signal provided by each group of the at least two groups of input control terminals and transmit the input control signal as amplified to a corresponding group of the first drive circuits.

In another aspect, a display drive circuit is provided. The display drive circuit is applied in a display panel, and includes a light-emitting drive circuit, and the drive control circuit as described in the above aspect;
wherein the drive control circuit is connected to the light-emitting drive circuit, and the light-emitting drive circuit is configured to connect to a pixel in the display panel; and

the drive control circuit is configured to control the light-emitting drive circuit to drive the pixel to emit light.

In some embodiments, the light-emitting drive circuit includes a gate drive circuit;
wherein the drive control circuit is configured to control the gate drive circuit to transmit a gate drive signal to the pixel to drive the pixel to emit light.

In yet another aspect, a display device is provided. The display device includes a display panel, and a display drive circuit as described in the another aspect above;
wherein the display panel includes a plurality of pixels; the display drive circuit is connected to the plurality of pixels, and the display drive circuit is configured to drive the plurality of pixels to emit light.

### BRIEF DESCRIPTION OF DRAWINGS

For clearer descriptions of the technical solutions in the embodiments of the present disclosure, the following briefly introduces the accompanying drawings required for describing the embodiments. Apparently, the accompanying drawings in the following description illustrate merely some embodiments of the present disclosure, and persons of ordinary skill in the art may still derive other drawings from these accompanying drawings without creative efforts.

FIG. 1 is a schematic structural diagram of a drive control circuit according to some embodiments of the present disclosure;

FIG. 2 is a schematic structural diagram of another drive control circuit according to some embodiments of the present disclosure;

FIG. 3 is a schematic structural diagram of yet another drive control circuit according to some embodiments of the present disclosure;

FIG. 4 is a schematic structural diagram of still another drive control circuit according to some embodiments of the present disclosure;

FIG. 5 is a schematic structural diagram of still another drive control circuit according to some embodiments of the present disclosure;

FIG. 6 is a schematic diagram of a circuit structure of a drive control circuit according to some embodiments of the present disclosure;

FIG. 7 is a schematic diagram of a circuit structure of another drive control circuit according to some embodiments of the present disclosure;

FIG. 8 is a schematic diagram of a circuit structure of yet another drive control circuit according to some embodiments of the present disclosure;

FIG. 9 is an operating equivalent circuit diagram of a drive control circuit shown on the basis of FIG. 6;

FIG. 10 is an operating equivalent circuit diagram of another drive control circuit shown on the basis of FIG. 6;

FIG. 11 is an operating equivalent circuit diagram of yet another drive control circuit shown on the basis of FIG. 6;

FIG. 12 is an operating equivalent circuit diagram of still another drive control circuit shown on the basis of FIG. 6;

FIG. 13 is an operating equivalent circuit diagram of still another drive control circuit shown on the basis of FIG. 6;

FIG. 14 is an operating equivalent circuit diagram of a drive control circuit shown on the basis of FIG. 7;

FIG. 15 is an operating equivalent circuit diagram of another drive control circuit shown on the basis of FIG. 7;

FIG. 16 is an operating equivalent circuit diagram of yet another drive control circuit shown on the basis of FIG. 7;

FIG. 17 is an operating equivalent circuit diagram of still another drive control circuit shown on the basis of FIG. 7;

FIG. 18 is an operating equivalent circuit diagram of still another drive control circuit shown on the basis of FIG. 7;

FIG. 19 is a schematic structural diagram of a power supply circuit according to some embodiments of the present disclosure;

FIG. 20 is a schematic structural diagram of another power supply circuit according to some embodiments of the present disclosure;

FIG. 21 is a schematic diagram of a circuit structure of a power supply circuit according to some embodiments of the present disclosure;

FIG. 22 is a schematic diagram of a circuit structure of a charge pump according to some embodiments of the present disclosure;

FIG. 23 is a schematic structural diagram of a display drive circuit according to some embodiments of the present disclosure; and

FIG. 24 is a schematic structural diagram of a display device according to some embodiments of the present disclosure.

### DETAILED DESCRIPTION

To make the objectives, technical solutions, and advantages of the present disclosure clearer, the following further describes the embodiments of the present disclosure in detail with reference to the accompanying drawings.

The transistors used in all embodiments of the present disclosure may be thin-film transistors, metal-oxide-semiconductor (MOS) field effect transistors, or other devices having the same characteristics, and the transistors used in the embodiments of the present disclosure are mainly switching transistors according to the roles in the circuit. As the source and the drain of the switching transistor are symmetrical, the source and the drain are interchangeable. In the embodiments of the present disclosure, the source is referred to as the first electrode, and the drain is referred to as the second electrode. In the form shown in the accompanying drawings, the middle terminal of the transistor is a control electrode, which may also be referred to as a gate, a signal input terminal is the source, and a signal output terminal is the drain. In addition, the switching transistor used in the embodiments of the present disclosure may include a P-type transistor or an N-type transistor, wherein the P-type transistor is turned on when the gate is at a low level and is turned off when the gate is at a high level, and the N-type transistor is turned on when the gate is at a high level and is turned off when in the case that the gate is at a low level. The plurality of signals in the embodiments of the present disclosure correspond to a first level and a second level. The first level and the second level represent only two state quantities of the level of the signal, and do not represent that the first level or the second level in the whole has a specific value.

With the development of display technology, display products such as mobile terminals are also gradually lightweight and convenient. In this way, the display products need to be smaller in size, to be lighter in weight, and can achieve a larger display area simultaneously. Correspondingly, it also limits the capacity of the power supply for supplying power to the display product is limited, and the requirement for low power consumption of the display product is more severe. At present, two parts with high power consumption in a display product include a light-emitting display device and a display driver integrated chip (DDIC). The light-emitting display device is, for example, an electroluminescent (EL) pixel, which includes a pixel circuit and an EL light-emitting element. The pixel circuit is connected to a display drive circuit and the light-emitting element, respectively, to drive the light-emitting element to emit light under the drive of the display drive circuit. A plurality of light-emitting drive circuits in the display drive circuit are disposed on the display panel by using the gate drive on array (GOA) technology, so as to facilitate a narrow-bezel design. Accordingly, the light-emitting drive circuit may also be called a GOA circuit. For example, a common gate drive GOA circuit.

The conventional EL pixel is mostly driven by a low-temperature poly-silicon (LTPS). That is, the pixel circuit mostly includes a P-type transistor (e.g., a PMOS transistor) prepared by the LTPS. However, it has been found through tests that in a scenario in which a low-frequency refresh is used to save power consumption, the leakage of the P-type transistor is relatively serious, resulting in poor light-emitting stability of a pixel, and resulting in an abnormal display of the display product due to a flickering display abnormality. Thus, the adoption of low-temperature polycrystalline silicon plus oxide (LTPO) drive technology is being considered. In other words, the pixel circuit includes a P-type transistor prepared by the LTPS and an N-type transistor (e.g., an NMOS transistor) prepared by Oxide. In this way, the advantage of the relatively small leakage of the N-type transistor can be utilized to ensure that a display abnormality, such as a flash screen, does not occur when the display is refreshed at a low frequency.

Firstly, a pixel circuit for an LTPO architecture currently uses a group of GOA circuits to transmit a drive signal to a pixel circuit of the LTPO architecture, so as to control the pixel circuit to drive the light-emitting element to emit light, which cannot flexibly meet the driving voltage requirements for driving the PMOS transistors and the NMOS transistors to operate.

Secondly, most of the current GOA circuits currently operate based on the drive power signal provided by the DDIC, resulting in the consumption of most power consumption of the DDIC. Moreover, as the DDIC includes a large number of other structures, both the response time and the power supply efficiency of the DDIC are low, and the load capacity is poor, which is not conducive to timely and reliably driving the GOA circuit. In addition, as the level of drive power signal required by the GOA circuit a generally high (e.g., 8 Volt V/−8 V), and the input power supply voltage to the DDIC is low, it is generally necessary to set a booster module in the DDIC. The boost module needs to occupy a large area of the DDIC, and the power consumption of the DDIC is large.

In the related art, a display drive circuit generally includes a drive control circuit and a light-emitting drive circuit. The drive control circuit is connected to a drive power terminal and the light-emitting drive circuit, and the light-emitting drive circuit is also connected to a pixel. The drive control circuit is configured to drive the light-emitting drive circuit to operate based on a drive power signal provided by the drive power terminal, i.e., to drive the light-emitting drive circuit to transmit a drive signal to the pixel, to drive the pixel to emit light.

However, limited by the selection of the drive power signal, the flexibility of driving the light-emitting driving circuit by the driving control circuit in the related art is poor.

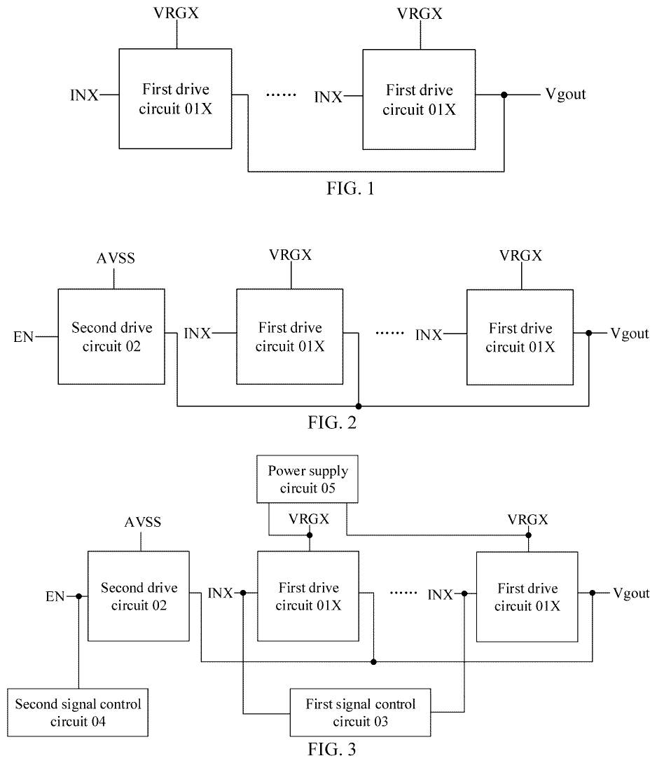

Based on the above, the embodiments of the present disclosure provide a new drive control circuit including a DDIC, which not only can flexibly meet the drive voltage requirements of the LTPO architecture, but also can improve the response time and the work efficiency, and save power consumption. FIG. 1 is a schematic structural diagram of a drive control circuit of a light-emitting drive circuit according to some embodiments of the present disclosure. As shown in FIG. 1, the drive control circuit includes at least two groups of first drive circuits 01X.

The at least two groups of first drive circuits 01X are connected to at least two groups of input control terminals INX, at least two groups of drive power terminals VRGX, and an output terminal Vgout, respectively. The output terminal Vgout is configured to be connected to a light-emitting drive circuit (not shown in the figure). In some embodiments, the light-emitting drive circuit may be, for example, a gate drive GOA circuit.

Levels of drive power signals provided by the at least two groups of drive power terminals VRGX are different. The at least two groups of input control terminals INX are in one-to-one correspondence with the at least two groups of first drive circuits 01X, the at least two groups of drive power terminals VRGX are in one-to-one correspondence with the at least two groups of first drive circuits 01X, and the at least two groups of input control terminals INX are in one-to-one to correspondence with the at least two groups of drive power terminals VRGX. It is to be understood that at least two groups of A being in one-to-one correspondence with at least two groups of B means that each group of A corresponds to one group of B, and groups of B corresponding to groups of A are different.

In some embodiments, each group of input control terminals INX may include one or more input control terminals. Correspondingly, each group of drive power terminals VRGX corresponding to each group of input control terminals INX may include the same number of one or more drive power terminals VRGX. For example, each group of input control terminals INX may include two input control terminals. Correspondingly, each group of drive power terminals VRGX may include two drive power terminals.

In addition, each group of first drive circuits 01X is configured to control, in response to an input control signal provided by the corresponding group of input control terminals INX, an on-off of the corresponding group of drive power terminals VRGX and the output terminal Vgout.

Exemplarily, each group of input control terminals INX includes two input control terminals, and each group of drive power terminals VRGX includes two drive power terminals. Each group of first drive circuits 01X can control, when the level of the input control signal provided by one input control terminal in the corresponding connected group of input control terminals INX is a first level, the one drive power terminal corresponding to one input control terminal to be turned on with the output terminal Vgout, such that the one drive power terminal transmits the drive power signal to the output terminal Vgout; and each group of first drive circuits 01X can control, when the level of the input control signal provided by the one input control terminal is a second level, the one drive power terminal corresponding to one input control terminal to be disconnected from the output terminal Vgout. Each group of first drive circuits 01X can control, when the level of the input control signal provided by the other input control terminal in the corresponding connected group of input control terminals INX is the first level, the other drive power terminal corresponding to the other input control terminal INX to be turned on with the output terminal Vgout, such that the other drive power terminal transmits the drive power signal to the output terminal Vgout; and each group of first drive circuits 01X can control, when the level of the input control signal provided by the other input control terminal is the second level, the other drive power terminal corresponding to the other input control terminal to be disconnected from the output terminal Vgout.

As the levels of the drive power signals provided by different drive power terminals are different, the input control signals are flexibly provided to each input control terminal, such that the drive control circuit can flexibly provide different levels of the drive power signals to the GOA circuit, so as to meet the drive voltage requirements of the LTPO architecture.

In some embodiments, the first level may be a high level relative to the second level, i.e., the first level is high level and the second level is low level. Alternatively, the first level may be a low level relative to the second level, i.e., the first level is low level and the second level is high level. The first levels of the input control signals provided by input control terminals in each group of input control terminals INX may be different, and the second levels may also be different.

In summary, the embodiments of the present disclosure provide a drive control circuit of a light-emitting drive circuit. The drive control circuit includes at least two groups of first drive circuits. The at least two groups of first drive circuits are connected to at least two groups of input control terminals and at least two groups of drive power terminals in one-to-one correspondence. Each group of first drive circuits can control, in response to an input control signal provided by a corresponding connected group of input control terminals, an on-off of the corresponding group of drive power terminals and the output terminal connected to the light-emitting drive circuit. In this way, the input control signal provided by each group of input control terminals can be flexibly set, such that the drive control circuit can flexibly provide drive power signals with different levels to the light-emitting drive circuit, thereby improving the flexibility of driving the light-emitting drive circuit.

In some embodiments, FIG. 2 is a schematic structural diagram of another drive control circuit according to some embodiments of the present disclosure. As shown in FIG. 2, the drive control circuit provided by the embodiments of the present disclosure may further include a second drive circuit 02.

The second drive circuit 02 may be connected to an enable control terminal EN, a pull-down power terminal AVSS, and the output terminal Vgout, respectively. The second drive circuit 02 may be configured to control, in response to an enable control signal provided by the enable control terminal EN, an on-off of the pull-down power terminal AVSS and the output terminal Vgout. In some embodiments, the pull-down power terminal AVSS may be a ground terminal GND.

Exemplarily, the second drive circuit 02 can control, when the level of the enable control signal provided by the enable control terminal EN is a first level, the pull-down power terminal AVSS to be turned on with the output terminal Vgout, such that a pull-down power signal provided by the pull-down power terminal AVSS is transmitted to the output terminal Vgout, that is, the output terminal Vgout is grounded; and the second drive circuit 02 can control, when the level of the enable control signal is a second level, the pull-down power terminal AVSS to be disconnected from the output terminal Vgout.

In some embodiments, FIG. 3 is a schematic structural diagram of yet another drive control circuit according to some embodiments of the present disclosure. As shown in FIG. 3, the drive control circuit in the embodiments of the present disclosure may further include a first signal control circuit 03, a second signal control circuit 04, and a power supply circuit 05.

The first signal control circuit 03 may be connected to the at least two groups of input control terminals INX. The first signal control circuit 03 may be configured to transmit an input control signal to each group of input control terminals INX.

The second signal control circuit 04 may be connected to the enable control terminal EN. The second signal control circuit 04 may be configured to transmit an enable control signal to the enable control terminal EN.

The power supply circuit 05 may be connected to the at least two groups of drive power terminals VRGX. The power supply circuit 05 may be configured to transmit drive power signals with different levels to each group of drive power terminals VRGX.

In some embodiments, the first signal control circuit 03 and the second signal control circuit 04 may be integrated, that is, may be of an integral structure and belong to two parts of the same signal control circuit. Alternatively, the first signal control circuit 03 and the second signal control circuit 04 may be independent of each other.

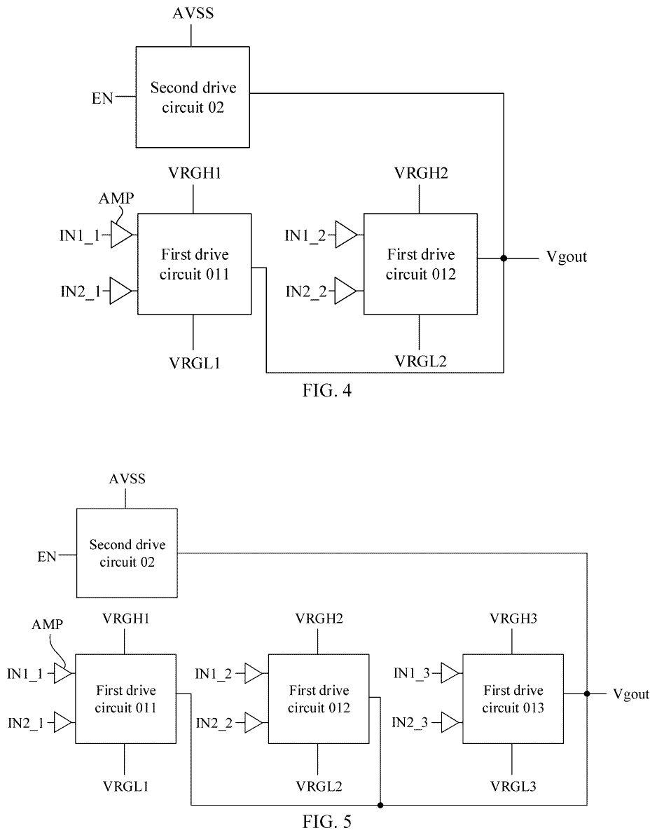

In some embodiments, FIG. 4 is a schematic structural diagram of still another drive control circuit according to some embodiments of the present disclosure. As shown in FIG. 4, each group of input control terminals INX may include a first input control terminal IN1 and a second input control terminal IN2. That is, each group of input control terminals INX may include two input control terminals. Each group of drive power terminals VRGX may include a first drive power terminal VRGH corresponding to the first input control terminal IN1, and a second drive power terminal VRGL corresponding to the second input control terminal IN2. That is, each group of drive power terminals VRGX may include two drive power terminals.

In addition, the level of the drive power signal provided by the first drive power terminal VRGH may be greater than the level of the drive power signal provided by the second drive power terminal VRGL. For example, the level of the drive power signal provided by the first drive power terminal VRGH may be 8V, and the level of the drive power signal provided by the second drive power terminal VRGL may be −8V.

Each group of first drive circuits 01X may be configured to control, in response to an input control signal provided by the first input control terminal IN1, an on-off of the first drive power terminal VRGH with the output terminal Vgout, and control, in response to an input control signal provided by the second input control terminal IN2, an on-off of the second drive power terminal VRGL with the output terminal Vgout.

Exemplarily, each group of first drive circuits 01X can control, when the level of the input control signal provided by the first input control terminal IN1 is a first level (e.g., high level), the first drive power terminal VRGH to be turned on with the output terminal Vgout; and can control, when the level of the input control signal provided by the first input control terminal IN1 is a second level (e.g., low level), the first drive power terminal VRGH to be disconnected from the output terminal Vgout. Each group of first drive circuits 01X can control, when the level of the input control signal provided by the second input control terminal IN2 is a first level (e.g., low level), the second drive power terminal VRGL to be turned on with the output terminal Vgout; and can control, when the level of the input control signal provided by the second input control terminal IN2 is a second level (e.g., high level), the second drive power terminal VRGL to be disconnected from the output terminal Vgout.

In some embodiments, referring to FIG. 4, it can be seen that the drive control circuit provided by the embodiments of the present disclosure may include two groups of first drive circuits 011 and 012. Alternatively, referring to FIG. 5, which is a schematic structural diagram of still another drive control circuit, it can be seen that the drive control circuit may include three groups of first drive circuits 011, 012, and 013. In addition, the drive control circuit may include more groups of first drive circuits, which is not limited in the embodiments of the present disclosure.

In addition, in order to distinguish, referring to FIG. 4, for the two groups of first drive circuits 011 and 012, the first input control terminal IN1 and the second input control terminal IN2 correspondingly connected to the first group of first drive circuits 011 are identified as IN1_1 and IN2_1, respectively. At the same time, the first drive power terminal VRGH and the second drive power terminal VRGL correspondingly connected to the first group of first drive circuits 011 are identified as VRGH1 and VRGL1, respectively. The first input control terminal IN1 and the second input control terminal IN2 correspondingly connected to the second group of first drive circuits 012 are identified as IN1_2 and IN2_2, respectively. At the same time, the first drive power terminal VRGH and the second drive power terminal VRGL correspondingly connected to the second group of first drive circuits 012 are identified as VRGH2 and VRGL2. Referring to FIG. 5, for the three groups of first drive circuits 011, 012, and 013, the first input control terminal IN1 and the second input control terminal IN2 correspondingly connected to the third group of first drive circuits 013 included in the figure with respect to FIG. 4 are identified as IN1_3 and IN2_3, respectively. At the same time, the first drive power terminal VRGH and the second drive power terminal VRGL correspondingly connected to the third group of first drive circuits 013 are identified as VRGH3 and VRGL3, respectively. The following accompanying drawings are identified by the same reference numerals and will not be repeated.

In some embodiments, referring to FIGS. 4 and 5, it can also be seen that the drive control circuit provided by the embodiments of the present disclosure may further include at least two groups of amplifiers (AMP).

The at least two groups of AMPs may be connected to the at least two groups of input control terminals INX and the at least two groups of first drive circuits 01X in one-to-one correspondence. The at least two groups of amplifiers AMP may be configured to amplify an input control signal provided by each group of input control terminals INX and then transmit the input control signal as amplified to the corresponding group of first drive circuits 01X. In this way, the output reliability of the input control signals can be improved, such that the first drive circuit 01X can reliably control the on-off of the drive power terminals VRGX and the output terminal.

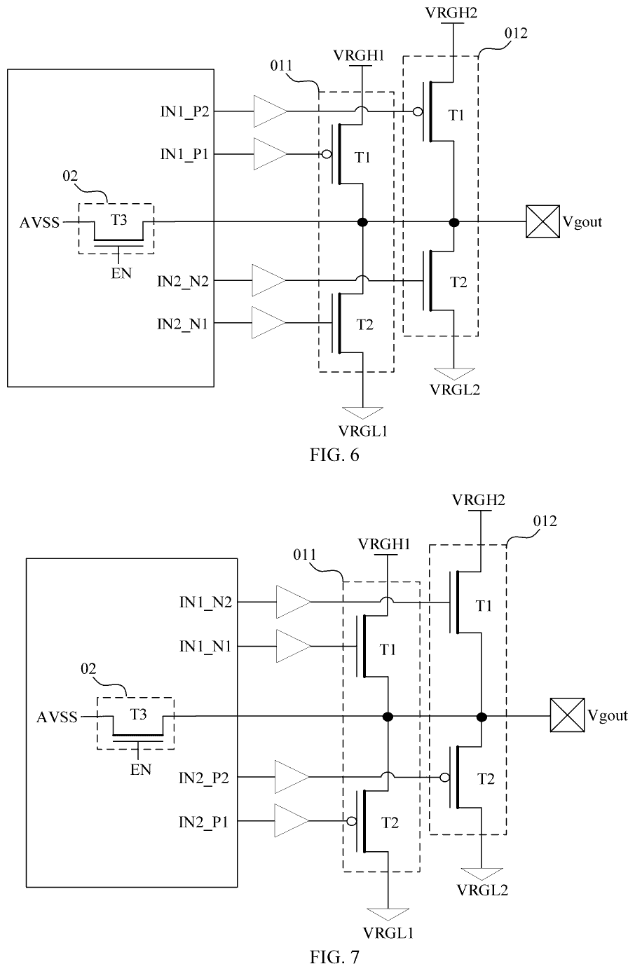

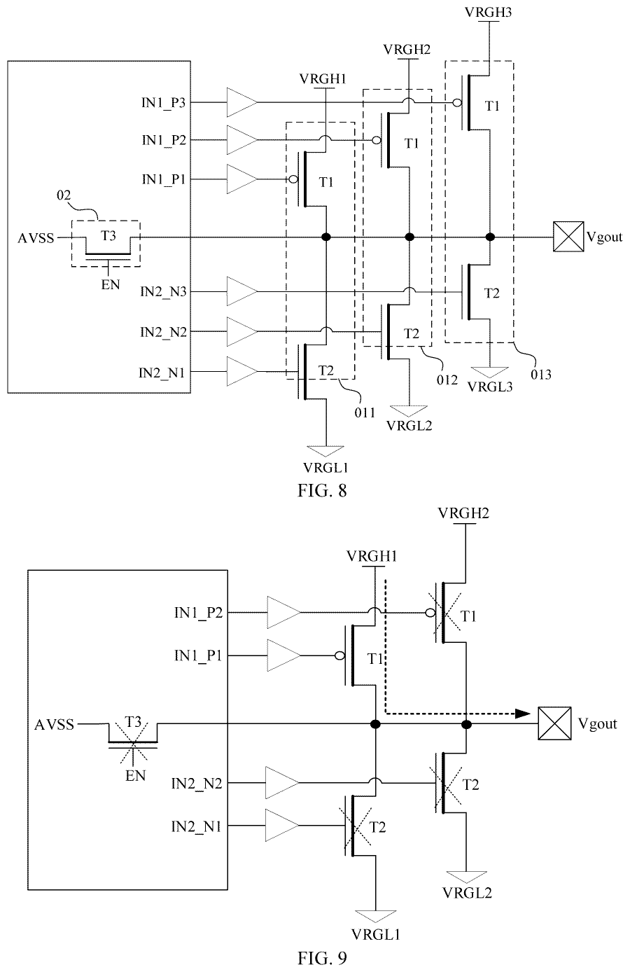

In some embodiments, taking FIG. 4 as an example, FIGS. 6 and 7 show schematic diagrams of a circuit structure of two drive control circuits, respectively. Taking FIG. 5 as an example, FIG. 8 shows a schematic diagram of a circuit structure of yet another drive control circuit. As shown in FIGS. 6 to 8, each group of first drive circuits 01X provided by the embodiments of the present disclosure may include a first transistor T1 and a second transistor T2.

A gate of the first transistor T1 may be connected to the first input control terminal IN1, a first electrode of the first transistor T1 may be connected to the first drive power terminal VRGH, and a second electrode of the first transistor T1 may be connected to the output terminal Vgout.

A gate of the second transistor T2 may be connected to the second input control terminal IN2, a first electrode of the second transistor T2 may be connected to the second drive power terminal VRGL, and a second electrode of the second transistor T2 may be connected to the output terminal Vgout.

In some embodiments, one of the first transistor T1 and the second transistor T2 may be a P-type transistor and the other one may be an N-type transistor.

Exemplarily, referring to FIGS. 6 and 8, which show the first transistor T1 being a P-type transistor (e.g., a PMOS transistor) and the second transistor T2 being an N-type transistor (e.g., an NMOS transistor). Accordingly, it can be seen that for each group of first drive circuits 01X shown in FIGS. 6 and 8, when the level of the input control signal provided by the first input control terminal IN1 is low, the first transistor T1 may be turned on, such that the first drive power terminal VRGH is turned on with the output terminal Vgout, and a high level of the drive power signal is transmitted to the output terminal Vgout. When the level of the input control signal provided by the first input control terminal IN1 is high, the first transistor T1 may be turned off, such that the first drive power terminal VRGH is disconnected from the output terminal Vgout. When the level of the input control signal provided by the second input control terminal IN2 is high, the second transistor T2 may be turned on, such that the second drive power terminal VRGL is turned on with the output terminal Vgout, and a low level of the drive power signal is transmitted to the output terminal Vgout. When the level of the input control signal provided by the second input control terminal IN2 is low, the second transistor T2 may be turned off, such that the second drive power terminal VRGL is disconnected from the output terminal Vgout.

Alternatively, referring to FIG. 7, which shows the first transistor T1 being an N-type transistor (e.g., an NMOS transistor) and the second transistor T2 being a P-type transistor (e.g., a PMOS transistor). Accordingly, it can be seen that for each group of the first drive circuits 01X shown in FIG. 7, when the level of the input control signal provided by the first input control terminal IN1 is high, the first transistor T1 may be turned on, such that the first drive power terminal VRGH is turned on with the output terminal Vgout, and a high level of the drive power signal is transmitted to the output terminal Vgout. When the level of the input control signal provided by the first input control terminal IN1 is low, the first transistor T1 may be turned off, such that the first drive power terminal VRGH is disconnected from the output terminal Vgout. When the level of the input control signal provided by the second input control terminal IN2 is low, the second transistor T2 may be turned on, such that the second drive power terminal VRGL is turned on with the output terminal Vgout, and a low level of the drive power signal is transmitted to the output terminal Vgout. When the level of the input control signal provided by the second input control terminal IN2 is high, the second transistor T2 may be turned off, such that the second drive power terminal VRGL is disconnected from the output terminal Vgout.

In order to distinguish, the first input control terminal IN1_1 connected to the P-type first transistor T1 in the first group of first drive circuits 011 is identified as IN1_P1 in FIG. 6 and FIG. 8, and the second input control terminal IN2_1 connected to the N-type second transistor T2 is identified as IN2_N1. At the same time, the first input control terminal IN1_2 connected to the P-type first transistor T1 in the second group of first drive circuits 012 is identified as IN1_P2, and the second input control terminal IN2_2 connected to the N-type second transistor T2 is identified as IN2_N2. In FIG. 7, the first input control terminal IN1_1 connected to the N-type first transistor T1 in the first group of first drive circuits 011 is identified as IN1_N1, and the second input control terminal IN2_1 connected to the P-type second transistor T2 is identified as IN2_P1. At the same time, the first input control terminal IN1_2 connected to the N-type first transistor T1 in the second group of first drive circuits 012 is identified as IN1_N2, and the second input control terminal IN2_2 connected to the P-type second transistor T2 is identified as IN2_P2. In FIG. 8, the first input control terminal IN1_3 connected to the P-type first transistor T1 in the third group of first drive circuits 013 is identified as IN1_P3, and the second input control terminal IN2_3 connected to the N-type second transistor T2 is identified as IN2_N3.

In some embodiments, referring to FIGS. 6 to 8, it can also be seen that the second drive circuit 02 may include a third transistor T3.

A gate of the third transistor T3 may be connected to the enable control terminal EN, a first electrode of the third transistor T3 may be connected to the pull-down power terminal AVSS, and a second electrode of the third transistor T3 may be connected to the output terminal Vgout.

In some embodiments, the third transistor T3 may be an N-type transistor (e.g., an NMOS transistor) as shown in FIGS. 6 to 8. Alternatively, in other embodiments, the third transistor T3 may also be a P-type transistor (e.g., a PMOS transistor).

In some embodiments, the AMP connected to the input control terminal and the gates of the transistors (including the first transistor T1 and the second transistor T2) is also schematically shown in each of FIGS. 6 to 8.

Taking the circuit shown in FIG. 6 as an example, in the following embodiments, at least two groups of first drive circuits in the drive control circuit are selected to output drive power signals with different levels for description:

(1) When the level of the input control signal provided by the first input control terminal IN1_P1 is a low (LOW) level and the level of the input control signal provided by the first input control terminal IN1_P2 is a high (HIGH) level, and at the same time, the levels of the input control signals provided by the second input control terminals IN2_N1 and IN2_N2 are both low levels, the first transistor T1 connected to the first input control terminal IN1_P1 is turned on, and the first transistor T1 connected to the first input control terminal IN1_P2, the second transistor T2 connected to the second input control terminal IN2_N1, and the second transistor T2 connected to the second input control terminal IN2_N2 are all turned off. Accordingly, the first drive power terminal VRGH1 is turned on with the output terminal Vgout, and the first drive power terminal VRGH2, the second drive power terminal VRGL1, and the second drive power terminal VRGL2 are disconnected from the output terminal Vgout. Further, the drive power signal provided by the first drive power terminal VRGH1 is transmitted to the output terminal Vgout. That is, the first group of first drive circuits 011 can be selected to output the drive power signal provided by the first drive power terminal VRGH1 to the output terminal Vgout. That is, the level value of the output terminal Vgout at this time is the level value of the drive power signal provided by the first drive power terminal VRGH1. Exemplarily, FIG. 9 shows a corresponding equivalent circuit diagram.

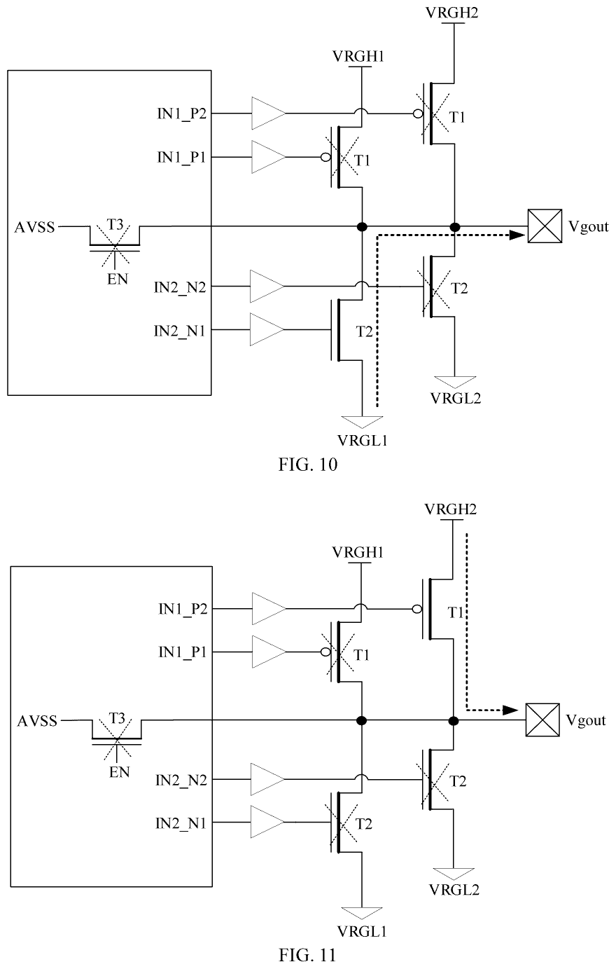

(2) When the level of the input control signal provided by the second input control terminal IN2_N1 is a high level and the level of the input control signal provided by the second input control terminal IN2_N2 is a low level, and at the same time the levels of the input control signals provided by the first input control terminals IN1_P1 and IN1_P2 are both high levels, the second transistor T2 connected to the second input control terminal IN2_N1 is turned on, and the second transistor T2 connected to the second input control terminal IN2_N2, the first transistor T1 connected to the first input control terminal IN1_P1, and the first transistor T1 connected to the first input control terminal IN1_P2 are all turned off. Accordingly, the second drive power terminal VRGL1 is turned on with the output terminal Vgout, and the second drive power terminal VRGL2, the first drive power terminal VRGH1, and the first drive power terminal VRGH2 are disconnected from the output terminal Vgout. Further, the drive power signal provided by the second drive power terminal VRGL1 is transmitted to the output terminal Vgout. That is, the first group of first drive circuits 011 can be selected to output the drive power signal provided by the second drive power terminal VRGL1 to the output terminal Vgout. That is, the level value of the output terminal Vgout at this time is the level value of the drive power signal provided by the second drive power terminal VRGL1. Exemplarily, FIG. 10 shows a corresponding equivalent circuit diagram.

(3) When the level of the input control signal provided by the first input control terminal IN1_P2 is a low level and the level of the input control signal provided by the first input control terminal IN1_P1 is a high level, and at the same time the levels of the input control signals provided by the second input control terminals IN2_N1 and IN2_N2 are both low levels, the first transistor T1 connected to the first input control terminal IN1_P2 is turned on, and the first transistor T1 connected to the first input control terminal IN1_P1, the second transistor T2 connected to the second input control terminal IN2_N1, and the second transistor T2 connected to the second input control terminal IN2_N2 are all turned off. Accordingly, the first drive power terminal VRGH2 is turned on with the output terminal Vgout, and the first drive power terminal VRGH1, the second drive power terminal VRGL1, and the second drive power terminal VRGL2 are disconnected from the output terminal Vgout. Further, the drive power signal provided by the first drive power terminal VRGH2 is transmitted to the output terminal Vgout. That is, the second group of first drive circuits 012 can be selected to output the drive power signal provided by the first drive power terminal VRGH2 to the output terminal Vgout. That is, the level value of the output terminal Vgout at this time is the level value of the drive power signal provided by the first drive power terminal VRGH2. Exemplarily, FIG. 11 shows a corresponding equivalent circuit diagram.

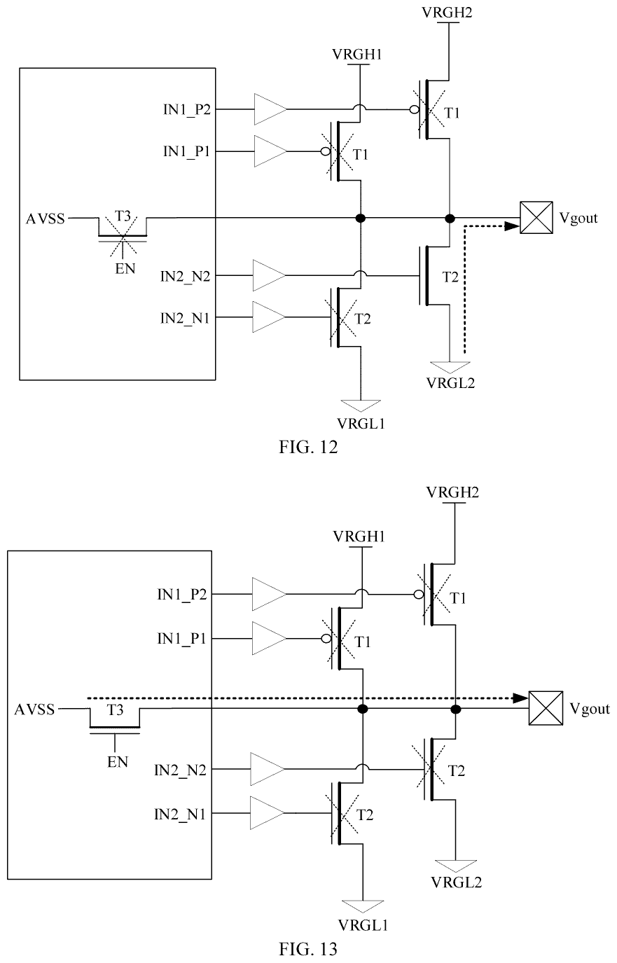

(4) When the level of the input control signal provided by the second input control terminal IN2_N2 is a high level and the level of the input control signal provided by the second input control terminal IN2_N1 is a low level, and at the same time the levels of the input control signals provided by the first input control terminals IN1_P1 and IN1_P2 are both high levels, the second transistor T2 connected to the second input control terminal IN2_N2 is turned on, and the second transistor T2 connected to the second input control terminal IN2_N1, the first transistor T1 connected to the first input control terminal IN1_P1, and the first transistor T1 connected to the first input control terminal IN1_P2 are all turned off. Accordingly, the second drive power terminal VRGL2 is turned on with the output terminal Vgout, and the second drive power terminal VRGL1, the first drive power terminal VRGH1, and the first drive power terminal VRGH2 are disconnected from the output terminal Vgout. Further, the drive power signal provided by the second drive power terminal VRGL2 is transmitted to the output terminal Vgout. That is, the second group of first drive circuits 012 can be selected to output the drive power signal provided by the second drive power terminal VRGL2 to the output terminal Vgout. That is, the level value of the output terminal Vgout at this time is the level value of the drive power signal provided by the second drive power terminal VRGL2. Exemplarily, FIG. 12 shows a corresponding equivalent circuit diagram.

In addition, for FIG. 6, on one hand, when the level of the enable control signal provided by the enable control terminal EN is a high level and levels of the input control signals provided by the first input control terminals IN1_P1 and IN1_P2 are both high levels, and at the same time, levels of the input control signals provided by the second input control terminals IN2_N1 and IN2_N2 are both low levels, the third transistor T3 is turned on, and each first transistor T1 and each second transistor T2 are turned off. Accordingly, the pull-down power terminal AVSS is turned on with the output terminal Vgout, and the first drive power terminals VRGH1 and VRGH2, and the second drive power terminals VRGL1 and VRGL2 are disconnected from the output terminal Vgout. That is, the level value of the output terminal Vgout at this time may be the level value of the pull-down power signal provided by the pull-down power terminal AVSS. In some embodiments, the pull-down power terminal AVSS may be the GND, and accordingly, the output terminal Vgout may be grounded at this time. Exemplarily, FIG. 13 shows a corresponding equivalent circuit diagram. On the other hand, when the level of the enable control signal provided by the enable control terminal EN is a low level, and at the same time the levels of the input control signals provided by the first input control terminals IN1_P1 and IN1_P2 are both high levels, and the levels of the input control signals provided by the second input control terminals IN2_N1 and IN2_N2 are both low levels, each first transistor T1, each second transistor T2 and each third transistor T3 are turned off. At this time, the output Vgout is in a floating state.

In summary, for the circuit structure shown in FIG. 6, the levels of the circuit structure shown in FIG. 6 are summarized as shown in Table 1 below.

TABLE 1

| Vgout | IN1_P1 | IN2_N1 | IN1_P2 | IN2_N2 | EN |
|---|---|---|---|---|---|
| VRGH1 | LOW | LOW | HIGH | LOW | LOW |
| VRGL1 | HIGH | HIGH | HIGH | LOW | LOW |
| VRGH2 | HIGH | LOW | LOW | LOW | LOW |
| VRGL2 | HIGH | LOW | HIGH | HIGH | LOW |
| AVSS(GND) | HIGH | LOW | HIGH | LOW | HIGH |
| Floating | HIGH | LOW | HIGH | LOW | LOW |

Taking the circuit shown in FIG. 7 as an example, in the following embodiments, at least two groups of first drive circuits in the drive control circuit are selected to output drive power signals with different levels for description:

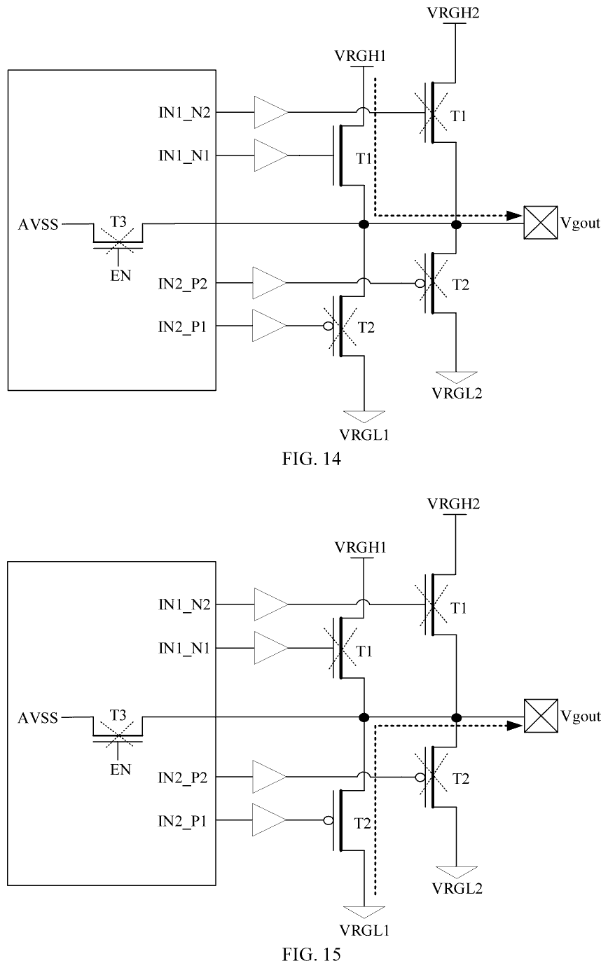

(1) When the level of the input control signal provided by the first input control terminal IN1_N1 is a high level and the level of the input control signal provided by the first input control terminal IN1_N2 is a low level, and at the same time, the levels of the input control signals provided by the second input control terminals IN2_P1 and IN2_P2 are both low levels, the first transistor T1 connected to the first input control terminal IN1_N1 is turned on, and the first transistor T1 connected to the first input control terminal IN1_N2, the second transistor T2 connected to the second input control terminal IN2_P1, and the second transistor T2 connected to the second input control terminal IN2_P2 are turned off. Accordingly, the first drive power terminal VRGH1 is turned on with the output terminal Vgout, and the first drive power terminal VRGH2, the second drive power terminal VRGL1, and the second drive power terminal VRGL2 are disconnected from the output terminal Vgout. Further, the drive power signal provided by the first drive power terminal VRGH1 is transmitted to the output terminal Vgout. That is, the first group of first drive circuits 011 can be selected to output the drive power signal provided by the first drive power terminal VRGH1 to the output terminal Vgout. That is, the level value of the output terminal Vgout at this time is the level value of the drive power signal provided by the first drive power terminal VRGH1. Exemplarily, FIG. 14 shows a corresponding equivalent circuit diagram.

(2) When the level of the input control signal provided by the second input control terminal IN2_P1 is a low level and the level of the input control signal provided by the second input control terminal IN2_P2 is a high level, and at the same time the levels of the input control signals provided by the first input control terminals IN1_N1 and IN1_N2 are both low levels, the second transistor T2 connected to the second input control terminal IN2_P1 is turned on, and the second transistor T2 connected to the second input control terminal IN2_P2, the first transistor T1 connected to the first input control terminal IN1_N1, and the first transistor T1 connected to the first input control terminal IN1_N2 are all turned off. Accordingly, the second drive power terminal VRGL1 is turned on with the output terminal Vgout, and the second drive power terminal VRGL2, the first drive power terminal VRGH1, and the first drive power terminal VRGH2 are disconnected from the output terminal Vgout. Further, the drive power signal provided by the second drive power terminal VRGL1 is transmitted to the output terminal Vgout. That is, the first group of first drive circuits 011 can be selected to output the drive power signal provided by the second drive power terminal VRGL1 to the output terminal Vgout. That is, the level value of the output terminal Vgout at this time is the level value of the drive power signal provided by the second drive power terminal VRGL1. Exemplarily, FIG. 15 shows a corresponding equivalent circuit diagram.

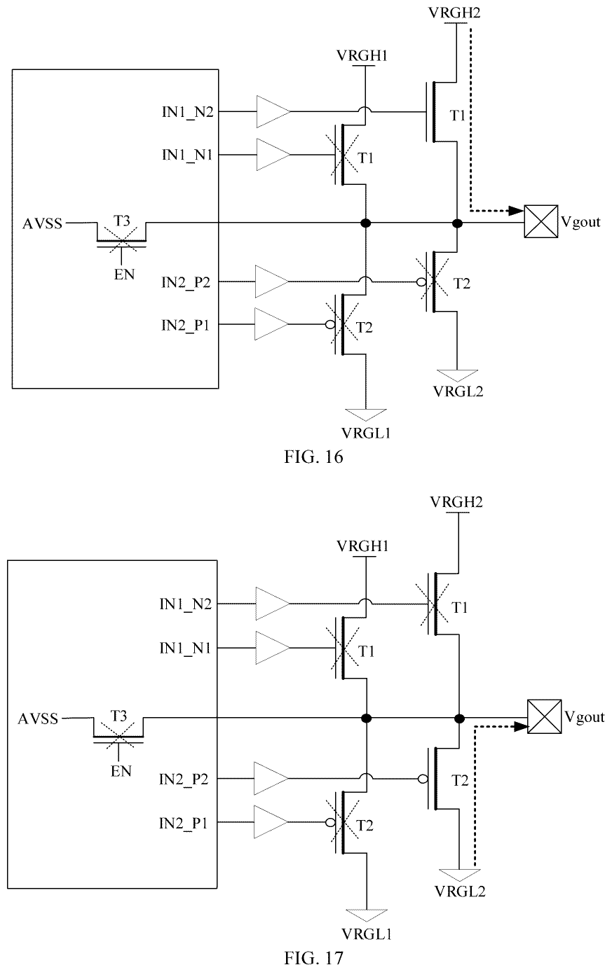

(3) When the level of the input control signal provided by the first input control terminal IN1_N2 is a high level and the level of the input control signal provided by the first input control terminal IN1_N1 is a low level, and at the same time the levels of the input control signals provided by the second input control terminals IN2_P1 and IN2_P2 are both high levels, the first transistor T1 connected to the first input control terminal IN1_N2 is turned on, and the first transistor T1 connected to the first input control terminal IN1_N1, the second transistor T2 connected to the second input control terminal IN2_P1, and the second transistor T2 connected to the second input control terminal IN2_P2 are all turned off. Accordingly, the first drive power terminal VRGH2 is turned on with the output terminal Vgout, and the first drive power terminal VRGH1, the second drive power terminal VRGL1, and the second drive power terminal VRGL2 are disconnected from the output terminal Vgout. Further, the drive power signal provided by the first drive power terminal VRGH2 is transmitted to the output terminal Vgout. That is, the second group of first drive circuits 012 can be selected to output the drive power signal provided by the first drive power terminal VRGH2 to the output terminal Vgout. That is, the level value of the output terminal Vgout at this time is the level value of the drive power signal provided by the first drive power terminal VRGH2. Exemplarily, FIG. 16 shows a corresponding equivalent circuit diagram.

(4) When the level of the input control signal provided by the second input control terminal IN2_P2 is a low level and the level of the input control signal provided by the second input control terminal IN2_P1 is a high level, and at the same time the levels of the input control signals provided by the first input control terminals IN1_N1 and IN1_N2 are both low levels, the second transistor T2 connected to the second input control terminal IN2_P2 is turned on, and the second transistor T2 connected to the second input control terminal IN2_P1, the first transistor T1 connected to the first input control terminal IN1_N1, and the first transistor T1 connected to the first input control terminal IN1_N2 are all turned off. Accordingly, the second drive power terminal VRGL2 is turned on with the output terminal Vgout, and the second drive power terminal VRGL1, the first drive power terminal VRGH1, and the first drive power terminal VRGH2 are disconnected from the output terminal Vgout. Further, the drive power signal provided by the second drive power terminal VRGL2 is transmitted to the output terminal Vgout. That is, the second group of first drive circuits 012 can be selected to output the drive power signal provided by the second drive power terminal VRGL2 to the output terminal Vgout. That is, the level value of the output terminal Vgout at this time is the level value of the drive power signal provided by the second drive power terminal VRGL2. Exemplarily, FIG. 17 shows a corresponding equivalent circuit diagram.

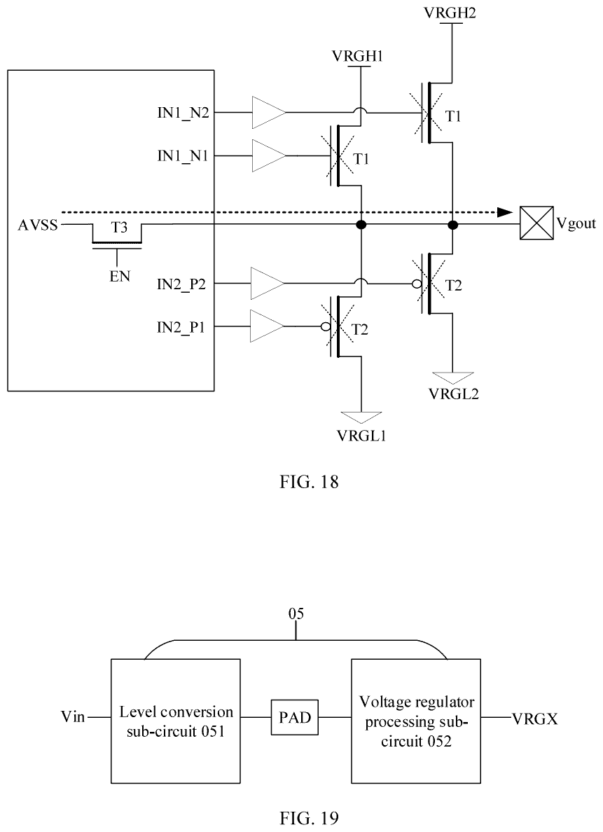

In addition, for FIG. 7, on the one hand, when the level of the enable control signal provided by the enable control terminal EN is a high level and the levels of the input control signals provided by the first input control terminals IN1_N1 and IN1_N2 are low levels, and at the same time, the levels of the input control signals provided by the second input control terminals IN2_P1 and IN2_P2 are high levels, the third transistor T3 is turned on, and each first transistor T1 and each second transistor T2 are turned off. Accordingly, the pull-down power terminal AVSS is turned on with the output terminal Vgout, and the first drive power terminals VRGH1 and VRGH2, and the second drive power terminals VRGL1 and VRGL2 are disconnected from the output terminal Vgout. That is, the level value of the output terminal Vgout at this time may be the level value of the pull-down power signal provided by the pull-down power terminal AVSS. In some embodiments, the pull-down power terminal AVSS may be the ground terminal GND, and accordingly, the output terminal Vgout may be grounded at this time. Exemplarily, FIG. 18 shows a corresponding equivalent circuit diagram. On the other hand, when the level of the enable control signal provided by the enable control terminal EN is a low level, and at the same time the levels of the input control signals provided by the first input control terminals IN1_N1 and IN1_N2 are both low levels, and the levels of the input control signals provided by the second input control terminals IN2_P1 and IN2_P2 are both high levels, each first transistor T1, each second transistor T2 and each third transistor T3 are turned off. At this time, the output Vgout is in a floating state.

In summary, for the circuit structure shown in FIG. 7, the levels of the circuit structure shown in FIG. 7 are summarized as shown in Table 2 below.

TABLE 2

| Vgout | IN1_P1 | IN2_N1 | IN1_P2 | IN2_N2 | EN |
|---|---|---|---|---|---|
| VRGH1 | HIGH | HIGH | HIGH | LOW | LOW |
| VRGL1 | LOW | LOW | HIGH | LOW | LOW |
| VRGH2 | HIGH | LOW | HIGH | HIGH | LOW |
| VRGL2 | HIGH | LOW | LOW | LOW | LOW |
| AVSS(GND) | HIGH | LOW | HIGH | LOW | HIGH |
| Floating | HIGH | LOW | HIGH | LOW | LOW |

Combined with the above embodiments, based on a control principle that the gate of the P-type transistor receives a low level signal to be turned on, and receives a high level signal to be turned off, and the gate of N-type transistor receives a high level signal to be turned on, and receives a low level signal to be turned off, the levels of the circuit structure shown in FIG. 8 are summarized as table 3 below, and the specific control modes are not described in detail.

TABLE 3

| Vgout | IN1_P1 | IN2_N1 | IN1_P2 | IN2_N2 | IN1_P3 | IN2_N3 | EN |
|---|---|---|---|---|---|---|---|
| VRGH1 | LOW | LOW | HIGH | LOW | HIGH | LOW | LOW |
| VRGL1 | HIGH | HIGH | HIGH | LOW | HIGH | LOW | LOW |
| VRGH2 | HIGH | LOW | LOW | LOW | HIGH | LOW | LOW |
| VRGL2 | HIGH | LOW | HIGH | HIGH | HIGH | LOW | LOW |
| VRGH3 | HIGH | LOW | HIGH | LOW | LOW | LOW | LOW |
| VRGL3 | HIGH | LOW | HIGH | LOW | HIGH | HIGH | LOW |
| AVSS(GND) | HIGH | LOW | HIGH | LOW | HIGH | LOW | HIGH |
| Floating | HIGH | LOW | HIGH | LOW | HIGH | LOW | LOW |

It can be known from the above-described embodiments that, by flexibly providing a high level or a low level input control signal to the input control terminal, drive power signals with different levels can be selected and output to the output terminal Vgout.

For any structure shown in FIGS. 6 to 8, a plurality of level selections can also be satisfied simultaneously. For example, combined with Table 1 corresponding to FIG. 6 and the related embodiments, both (1) and (2) may be satisfied simultaneously, i.e., the first transistor T1 and the second transistor T2 in the first group of first drive circuits 011 may be both turned on, and the first transistor T1 and the second transistor T2 in the second group of first drive circuits 012 may be both turned off. The first group of first drive circuits 011 can be selected to output the drive power signals provided by the first drive power terminal VRGH1 and the second drive power terminal VRGL1 to the output terminal Vgout. Alternatively, both (3) and (4) may be satisfied, i.e., the first transistor T1 and the second transistor T2 in the first group of first drive circuits 011 may be both turned off, and the first transistor T1 and the second transistor T2 in the second group of first drive circuits 012 may be both turned on. The second group of first drive circuits 012 can be selected to output the drive power signals provided by the first drive power terminal VRGH2 and the second drive power terminal VRGL2 to the output terminal Vgout.

In some embodiments, FIG. 19 shows a schematic structural diagram of a power supply circuit. As shown in FIG. 19, the power supply circuit 05 may include a level conversion sub-circuit 051 and a voltage regulator processing sub-circuit 052.

The level conversion sub-circuit 051 may be connected to an input power terminal Vin and an output pin PAD, respectively. The level conversion sub-circuit 051 may be configured to perform level conversion on an input power signal provided by the input power terminal Vin and then transmit the input power signal that is performed level conversion to the output pin PAD.

The voltage regulator processing sub-circuit 052 may be connected to the output pin PAD and the at least two groups of drive power terminals VRGX, respectively. The voltage regulator processing sub-circuit 052 may be configured to transmit the drive power signals with different levels to the at least two groups of drive power terminals VRGX based on the received input power signals.

It may be understood that the signals transmitted to the output pin PAD by the level conversion sub-circuit 051 may include one group of drive power signals (e.g., VGH/VGL), and then processed by the next level voltage regulator processing sub-circuit 052. The one group of drive power signals may be converted into at least two groups of drive power signals with different levels required to be provided to the at least two groups of drive power terminals VRGX, respectively.

In some embodiments, both the level conversion sub-circuit 051 and the voltage regulator processing sub-circuit 052 may include an analog circuit.

In some embodiments, as described above, the drive control circuit may further include a display driver integrated chip (DDIC). The level conversion sub-circuit 051 may include a charge pump integrated in the DDIC, and/or, a charge pump independent of the DDIC.

That is, in the embodiments of the present disclosure, the charge pump may be integrated in the DDIC or be independent of the DDIC. The charge pump may be configured to boost the level. Transmitting the drive power signal through the charge pump integrated in the DDIC may be considered an internal power supply, and transmitting the drive power signal through the charge pump independent of the DDIC may be considered an external power supply. Compared with the internal power supply, the external power supply may not be limited to other structures inside the DDIC, such that the power supply efficiency is relatively high, the response time is relatively fast, and the internal power consumption of the DDIC can be saved at the same time may. In addition, on the basis of the external power supply, the charge pump in the DDIC can be selectively removed, thereby reducing the size of the DDIC and facilitating the bonding of modules in the display product.

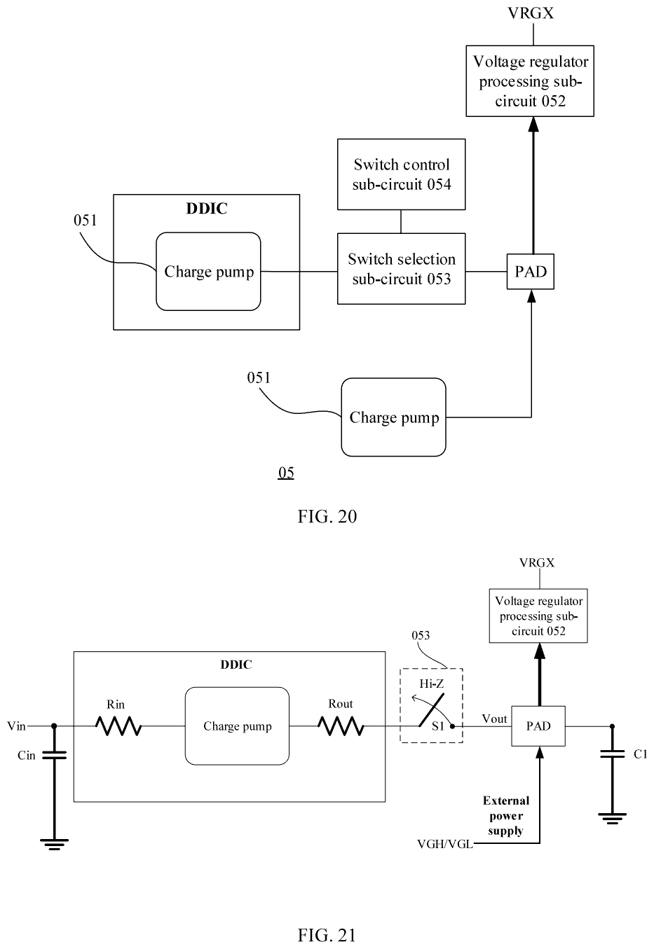

Taking the level conversion sub-circuit 051 including a charge pump integrated in the DDIC and a charge pump independent of the DDIC, i.e., not only the charge pump being provided in the DDIC, but also the charge pump being provided outside the DDIC as an example, referring to FIG. 20, FIG. 20 shows a schematic structural diagram of another power supply circuit, it can be seen that the power supply circuit 05 in the embodiments of the present disclosure may also include a switch selection sub-circuit 053 and a switch control sub-circuit 054.

The switch selection sub-circuit 053 may be connected to a switch control terminal (not shown), the charge pump in the DDIC, and the output pin PAD, respectively. The switch selection sub-circuit 053 may be configured to control, in response to a switch control signal provided by the switch control terminal, an on-off of the charge pump in the DDIC and the output pin PAD.

The switch control sub-circuit 054 may be connected to the switch control terminal. The switch control sub-circuit 054 may be configured to transmit the switch control signal to the switch control terminal.

That is, the switch selection sub-circuit 053 can be configured to flexibly select whether to use the charge pump integrated in the DDIC or use the charge pump independent of the DDIC by controlling an on-off of the DDIC and the output pin PAD. For an external charge pump, the external power supply can be stopped while the charge pump in the DDIC is internally powered.

In some embodiments, based on FIG. 20, FIG. 21 shows a schematic structural diagram of a power circuit. As shown in FIG. 21, the switch selector sub-circuit 053 may include a single-electrode single-throw switch S1.

A control terminal of the single-electrode single-throw switch S1 may be connected to the switch control terminal (not shown), a first terminal of the single-electrode single-throw switch S1 may be connected to the charge pump in the DDIC, and a second terminal of the single-electrode single-throw switch S1 may be connected to the output pin PAD.

In some embodiments, the single-electrode single-throw switch S1 may be a high-impedance Hi-Z switch. On this basis, the switch control sub-circuit 054 may include a register. That is, the Hi-Z switch may be configured to control the on-off of the charge pump in the DDIC and the output pin PAD through the register. In other embodiments, the single-electrode single-throw switch S1 may also be replaced with a switching transistor, which is not limited in the embodiments of the present disclosure.

In some embodiments, both the switch control sub-circuit 054 (e.g., the register) and the voltage regulator processing sub-circuit 052 may be integrated in the DDIC. The first drive circuit, the second drive circuit, the first signal control circuit, and the second signal control circuit may also be integrated in the DDIC, so as to facilitate circuit integration and module bonding.

In some embodiments, the drive control circuit may further include a power management integrated circuit (PMIC).

In a scenario where the charge pump is independently provided in the DDIC, i.e., external power supply, the charge pump can be integrated in the PMIC, alternatively, the charge pump can be independent of the PMIC. That is, the charge pump can be arranged in the PMIC for external power supply, or the external charge pump can also be directly and independently provided for external power supply.

In some embodiments, referring to FIG. 21, it can also be seen that one end of the charge pump in the DDIC can be connected to the input power terminal Vin through an input resistor Rin, and the other end of the charge pump in the DDIC can be connected to the output pin PAD through an output resistor Rout. In addition, the circuit structure shown in FIG. 21 also includes a filter capacitor C1 connected between the output pin PAD and the ground terminal. The resistor and the capacitor are provided to ensure the reliability of signal transmission.

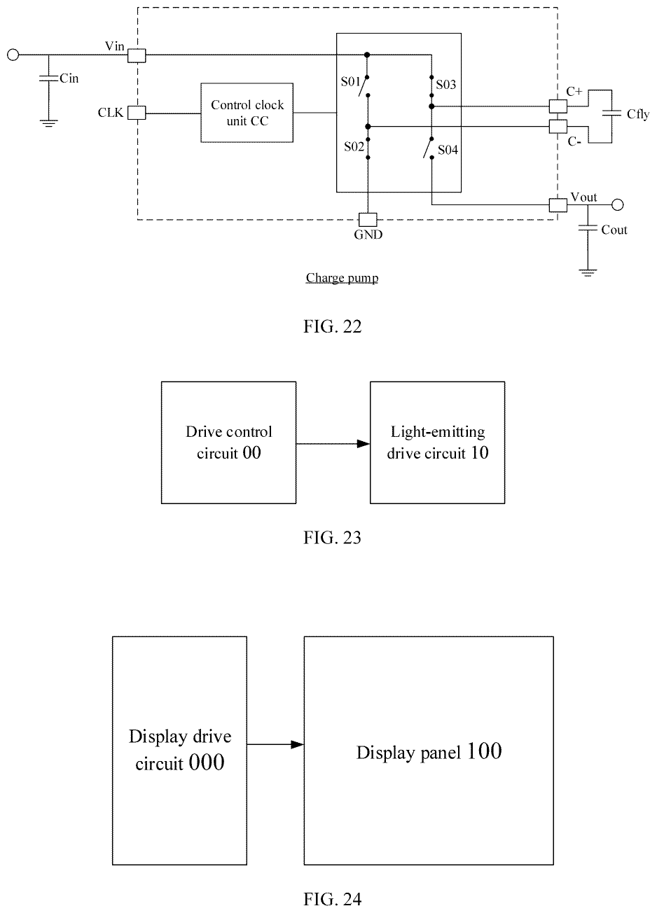

In some embodiments, FIG. 22 shows a schematic diagram of a circuit structure of a charge pump. As shown in FIG. 22, the charge pump may include a clock control (CC) unit and four switches S01, S02, S03, and S04. The four switches S01 to S04 may be connected between an input power terminal Vin and an output terminal Vout, and may also be connected to an external capacitor Cfly and a ground terminal GND, respectively. The clock control unit CC may be connected to a clock terminal CLK and the four switches S01 to S04, respectively. In addition, an input capacitor Cin is connected between the input power terminal Vin and the ground terminal GND, and an output capacitor Cout is connected between the output terminal Vout and the ground terminal GND. In conjunction with FIG. 21, the output terminal Vout may be connected to the output pin PAD through the single-electrode single-throw switch S1.

The charge pump circuit shown in FIG. 22 can achieve the purpose of boosting by charging and discharging the external capacitor Cfly through the four switches S01 to S04 using the characteristic that the voltage difference between two ends of the capacitor does not jump. For example, during charging, the clock control unit CC may control the switches S02 and S03 to be turned on based on a clock signal provided by the clock terminal CLK to charge the external capacitor Cfly, at this time, C+ voltage at the upper end of the external capacitor Cfly may be the voltage VVin of the input power signal provided by the input power terminal Vin, and C− at the lower end may be grounded. During discharging, the clock control unit CC may control the switches S01 and S04 to be turned on based on the clock signal provided by the clock terminal CLK to discharge the external capacitor Cfly, at this time, the C-voltage at the lower end of the external capacitor may be the voltage VVin of the input power signal, and the voltage of the output terminal Vout may be 2VVin under the characteristic that the voltage difference between two ends of the capacitor does not jump.

In some other embodiments, the charge pump can be replaced by other circuits with a boost function. For example, a boost circuit.

Based on the above embodiments, it can be seen that, on the one hand, the embodiments of the present disclosure can provide at least two groups of first drive circuits, to flexibly output drive power signals with different levels to the GOA circuit, so as to meet the drive voltage requirements of the LTPO architecture. On the other hand, the power supply efficiency and the circuit response time can be improved through the external power supply cooperation with the internal power supply of the DDIC, such that the operating power consumption of the circuit is saved. In addition, in an external power supply scenario, the charge pump inside the DDIC may also be removed to reduce the size of the DDIC and the power consumption of the DDIC.

It is to be understood that the GOA circuit may include a plurality of cascaded GOA units, and each GOA unit may be connected to a signal terminal such as a start terminal STV, a clock signal terminal CK, and a reset signal terminal RST, respectively, to transmit the drive signal to the pixel circuit under the control of each of the connected signal terminals, thereby causing the pixel circuit to drive the light-emitting element to emit light reliably. The output terminal Vgout of the drive control circuit described in the embodiments of the present disclosure may be connected to any signal terminal connected to each GOA unit, so as to provide the required drive power signal thereto.

In summary, the embodiments of the present disclosure provide a drive control circuit of a light-emitting drive circuit. The drive control circuit includes at least two groups of first drive circuits. The at least two groups of first drive circuits are connected to at least two groups of input control terminals and at least two groups of drive power terminals in one-to-one correspondence. Each group of first drive circuits can control, in response to an input control signal provided by a corresponding connected group of input control terminals, an on-off of the corresponding group of drive power terminals and the output terminal connected to the light-emitting drive circuit. In this way, the input control signal provided by each group of input control terminals can be flexibly set, such that the drive control circuit can flexibly provide drive power signals with different levels to the light-emitting drive circuit, thereby improving the flexibility of driving the light-emitting drive circuit.

FIG. 23 is a schematic diagram of a display drive circuit according to some embodiments of the present disclosure. The display drive circuit is applied in a display panel. As shown in FIG. 23, the display drive circuit includes a light-emitting drive circuit 10, and the drive control circuit 00 provided by the embodiments of the present disclosure in the above embodiments.

The drive control circuit 00 is connected to the light-emitting drive circuit 10, and the light-emitting drive circuit 10 is configured to connect to the pixels in the display panel. The drive control circuit 00 is configured to control the light-emitting drive circuit 10 to drive the pixels to emit light.

For example, the light-emitting drive circuit 10 may include a gate drive circuit. The drive control circuit 00 may be configured to control the gate drive circuit to transmit a gate drive signal to the pixel to drive the pixel to emit light. For example, the drive control circuit 00 may transmit the required drive power signal to the gate drive circuit to cause the gate drive circuit to transmit the gate drive signal to the pixel circuit in the pixel, so as to drive the pixel circuit to reliably control the light-emitting element to emit light.

In other embodiments, the pixel circuit also needs to receive a light-emitting control signal and a reset control signal to drive the light-emitting element to emit light. In this scenario, the light-emitting drive circuit 10 may also be a reset control drive circuit that transmits the reset control signal to the pixel; or, a light-emitting control drive circuit that transmits the light-emitting control signal to the pixel.

In some embodiments, as described above, the light-emitting drive circuit 10 may be provided on the display panel using GOA technology, i.e., the light-emitting drive circuit 10 may be the GOA circuit to facilitate the narrow bezel design of the display product.

FIG. 24 is a schematic structural diagram of a display device according to some embodiments of the present disclosure. As shown in FIG. 24, the display device includes a display panel 100 and a display drive circuit 000 as shown in FIG. 23.

The display panel 100 includes a plurality of pixels (not shown). A display drive circuit 000 is connected to the plurality of pixels, and the display drive circuit 000 is configured to drive the plurality of pixels to emit light.

In some embodiments, the display device may be any product or component having a display function, such as electronic paper, a mobile phone, a tablet computer, a television, a display, a laptop computer, or a navigator.

It should be understood that the terms used in the embodiments of the present disclosure are used only for the purpose of explaining the embodiments of the present disclosure and are not intended to limit the present disclosure. Unless otherwise defined, technical terms or scientific terms used in the embodiments of the present disclosure should have the ordinary meaning understood by a person of ordinary skill in the art to which the present disclosure belongs.

For example, the terms “first,” “second,” or “third,” and similar words used in the specification and claims of the present disclosure do not denote any order, quantity, or importance, but are merely used to distinguish different components. Likewise, similar words such as “a” or “an” do not denote a quantity limitation, but indicate that there is at least one. The terms such as “include,” “comprise,” and the like are intended to indicate that the element or objects before “include” or “comprise” encompass the elements or objects listed after “include” or “comprise” and their equivalents, and do not exclude other elements or objects. The terms “upper,” “lower,” “left,” or “right” are only used to represent relative position relationships, and when the absolute position of the described object is changed, the relative position relationship may also be changed accordingly. “Connected” refers to an electrical connection. “and/or” indicates that there may be three relationships, e.g., A and/or B may indicate that A exists alone, A and B exist at the same time, and B exists alone. The character “/” generally indicates an “or” relationship between the associated objects.

The above are only optional embodiments of the present disclosure and are not intended to limit the present disclosure, and any modifications, equivalent substitutions, improvements, and the like made within the spirit and principles of the present disclosure shall be included in the scope of protection of the present disclosure.

1. A drive control circuit of a light-emitting drive circuit, comprising:
at least two groups of first drive circuits, connected to at least two groups of input control terminals, at least two groups of drive power terminals, and an output terminal configured to connect to the light-emitting drive circuit; wherein levels of drive power signals provided by the at least two groups of drive power terminals are different, the at least two groups of input control terminals are in one-to-one correspondence with the at least two groups of first drive circuits, the at least two groups of drive power terminals are in one-to-one correspondence with the at least two groups of first drive circuits, and the at least two groups of input control terminals are in one-to-one correspondence with the at least two groups of drive power terminals;
wherein each group of the at least two groups of first drive circuits is configured to control, in response to an input control signal provided by a corresponding group of input control terminals, an on-off of a corresponding group of drive power terminals and the output terminal.

2. The drive control circuit according to claim 1, wherein each group of the at least two groups of input control terminals comprises a first input control terminal and a second input control terminal; and each group of the at least two groups of drive power terminals comprises a first drive power terminal corresponding to the first input control terminal, and a second drive power terminal corresponding to the second input control terminal; wherein a level of a drive power signal provided by the first drive power terminal is greater than a level of the drive power signal provided by the second drive power terminal; and
each group of the at least two groups of first drive circuits is configured to control, in response to an input control signal provided by the first input control terminal, an on-off of the first drive power terminal and the output terminal, and control, in response to an input control signal provided by the second input control terminal, an on-off of the second drive power terminal and the output terminal.

3. The drive control circuit according to claim 2, wherein the each group of the at least two groups of the first drive circuits comprises a first transistor and a second transistor;
wherein a gate of the first transistor is connected to the first input control terminal, a first electrode of the first transistor is connected to the first drive power terminal, and a second electrode of the first transistor is connected to the output terminal; and
a gate of the second transistor is connected to the second input control terminal, a first electrode of the second transistor is connected to the second drive power terminal, and a second electrode of the second transistor is connected to the output terminal.

4. The drive control circuit according to claim 3, wherein one of the first transistor and the second transistor is a P-type transistor, and another of the first transistor and the second transistor is an N-type transistor.

5. The drive control circuit according to claim 1, further comprising:
a first signal control circuit, connected to the at least two groups of input control terminals, and configured to transmit an input control signal to each group of the at least two groups of input control terminals.

6. The drive control circuit according to claim 1, further comprising:
a second drive circuit, connected to an enable control terminal, a pull-down power terminal, and the output terminal, and configured to control, in response to an enable control signal provided by the enable control terminal, an on-off of the pull-down power terminal and the output terminal.

7. The drive control circuit according to claim 6, wherein the second drive circuit comprises a third transistor;
wherein a gate of the third transistor is connected to the enable control terminal, a first electrode of the third transistor is connected to the pull-down power terminal, and a second electrode of the third transistor is connected to the output terminal.

8. The drive control circuit according to claim 6, further comprising:
a second signal control circuit, connected to the enable control terminal, and configured to transmit an enable control signal to the enable control terminal.

9. The drive control circuit according to claim 1, further comprising:
a power supply circuit, connected to the at least two groups of drive power terminals, and configured to transmit drive power signals with different levels to the at least two groups of drive power terminals.

10. The drive control circuit according to claim 9, wherein the power supply circuit comprises:
a level conversion sub-circuit, connected to an input power terminal and an output pin, and configured to perform level conversion on an input power signal provided by the input power terminal and transmit the input power signal that is performed level conversion to the output pin; and
a voltage regulator processing sub-circuit, connected to the output pin and the at least two groups of drive power terminals, and configured to transmit the drive power signals with different levels to the at least two groups of drive power terminals based on the input power signal as received.

11. The drive control circuit according to claim 10, further comprising a display driver integrated chip (DDIC); wherein the level conversion sub-circuit comprises:
a charge pump integrated in the DDIC;
and/or, a charge pump independent of the DDIC.

12. The drive control circuit according to claim 11, wherein the level conversion sub-circuit comprises a charge pump integrated in the DDIC, and a charge pump independent of the DDIC; and the power supply circuit further comprises:
a switch selection sub-circuit, connected to a switch control terminal, the charge pump in the DDIC, and the output pin, and configured to control, in response to a switch control signal provided by the switch control terminal, an on-off of the charge pump in the DDIC and the output pin; and
a switch control sub-circuit, connected to the switch control terminal, and configured to transmit the switch control signal to the switch control terminal.

13. The drive control circuit according to claim 12, wherein the switch selection sub-circuit comprises a single-electrode single-throw switch;
wherein a control terminal of the single-electrode single-throw switch is connected to the switch control terminal, a first terminal of the single-electrode single-throw switch is connected to the charge pump in the DDIC, and a second terminal of the single-electrode single-throw switch is connected to the output pin.

14. The drive control circuit according to claim 13, wherein the single-electrode single-throw switch is a high-impedance switch, and the switch control sub-circuit comprises a register.

15. The drive control circuit according to claim 12, wherein the switch control sub-circuit and the voltage regulator processing sub-circuit are both integrated in the DDIC.

16. The drive control circuit according to claim 11, further comprising a power management integrated chip (PMIC);
wherein the level conversion sub-circuit comprises a charge pump independent of the DDIC, wherein the charge pump independent of the DDIC is integrated in the PMIC, or the charge pump independent of the DDIC is independent of the PMIC.

17. The drive control circuit according to claim 1, further comprising:
at least two groups of amplifiers, connected to the at least two groups of input control terminals and the at least two groups of first drive circuits in one-to-one correspondence, and configured to amplify an input control signal provided by each group of the at least two groups of input control terminals and transmit the input control signal as amplified to a corresponding group of the first drive circuits.

18. A display drive circuit, applied in a display panel, and comprising a light-emitting drive circuit, and a drive control circuit;
wherein the drive control circuit is connected to the light-emitting drive circuit, and the light-emitting drive circuit is configured to connect to a pixel in the display panel;
the drive control circuit is configured to control the light-emitting drive circuit to drive the pixel to emit light; and
the drive control circuit comprises:
at least two groups of first drive circuits, connected to at least two groups of input control terminals, at least two groups of drive power terminals, and an output terminal configured to connect to the light-emitting drive circuit; wherein levels of drive power signals provided by the at least two groups of drive power terminals are different, the at least two groups of input control terminals are in one-to-one correspondence with the at least two groups of first drive circuits, the at least two groups of drive power terminals are in one-to-one correspondence with the at least two groups of first drive circuits, and the at least two groups of input control terminals are in one-to-one correspondence with the at least two groups of drive power terminals;
wherein each group of the at least two groups of first drive circuits is configured to control, in response to an input control signal provided by a corresponding group of input control terminals, an on-off of a corresponding group of drive power terminals and the output terminal.

19. The display drive circuit according to claim 18, wherein the light-emitting drive circuit comprises a gate drive circuit;
wherein the drive control circuit is configured to control the gate drive circuit to transmit a gate drive signal to the pixel to drive the pixel to emit light.

20. A display device, comprising a display panel, and the display drive circuit as defined in claim 18;
wherein the display panel comprises a plurality of pixels; the display drive circuit is connected to the plurality of pixels, and the display drive circuit is configured to drive the plurality of pixels to emit light.
